(19) United States
(12) Patent Application Publication
(10) Pub. No.: US 2005/0093845 A1
(43) Pub. Date: May 5, 2005

(54) System, computer program product, and method for capturing and processing form data

(75) Inventors: Ezekiel Brooks, Raleigh, NC (US); Gregory J. Clary, Apex, NC (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Advanced Digital Systems, Inc., Research Triangle Park, NC (US)

(21) Appl. No.: 11/012,665

(22) Filed: Dec. 15, 2004

Related U.S. Application Data
(62) Division of application No. 10/059,478, filed on Jan. 29, 2002.
(60) Provisional application No. 60/265,812, filed on Feb. 1, 2001.

(51) Int. Cl. G09G 5/00

(52) U.S. Cl. 345/179

(57) ABSTRACT

A system for communicating packaged data includes a pen-enabled computing device and a second computing device. The pen-enabled computing device includes a handwriting capture interface, a user interface and a processing element. The handwriting capture interface is capable of receiving and capturing an electronic handwriting input within at least one input field of an electronic form based upon a position of a writing stylus. To facilitate proper operation of the pen-enabled computing device, the user interface is adapted to provide feedback, such as aural, visual and/or vibration feedback, based upon the electronic handwriting input. The pen-enabled computing device is capable of transmitting packaged data including at least one form identifier and processed electronic handwriting input. Thereafter, the second computing device is capable of receiving the packaged data and then verifying the processed electronic handwriting input.

### CROSS-REFERENCE TO RELATED APPLICATIONS

This application is a divisional of U.S. application Ser. No. 10/059,478, filed Jan. 29, 2002, which is hereby incorporated herein in its entirety by reference.

### FIELD OF THE INVENTION

The present invention relates generally to the processing of form information and, more particularly, to systems, computer program products and methods for transmitting and processing form data.

### BACKGROUND OF THE INVENTION

Pen-enabled computing is a relatively recent development wherein a user interfaces with a computing system by way of a writing stylus instead of a mouse or a keyboard. In some instances, a pen-enabled computing system provides an electronic writing tablet having an overlaid writing surface. Such a writing surface may comprise, for example, a blank sheet of paper or a preprinted form. The writing stylus, in turn, may comprise a device capable of inputting data (a “handwriting input”) into the pen-enabled computing system while providing both a visible, or “written ink,” copy of the data on the writing surface and an “electronic” copy of the data within the pen-enabled computing system. Such a writing stylus may comprise, for example, a conventional pen, a conventional pencil, a radio transmitter, a magnetic or electric field device, an optical device, an ultrasound transceiver, or combinations thereof.

Once the electronic copy of the data is entered into the pen-enabled computing system, the data may be stored as an “electronic ink” copy, wherein the handwriting input is captured as written, or as a “text” copy, wherein the handwriting input is captured, recognized, and translated into the corresponding text. In some instances, the pen-enabled computing system may be capable of producing both an electronic ink and a text copy of the handwriting input. Since the writing stylus is generally capable of providing a written ink copy of the handwriting input on the writing surface, the user is automatically provided with a hard copy, or visual feedback, of the entered data. It is understood, however, that a written ink copy of the handwriting input may not be provided in some instances, wherein the handwriting input is only captured and stored in the pen-enabled computing system as an electronic copy. Examples of pen-enabled computing devices include the CrossPad™ portable digital notepad by the A. T. Cross Company of Lincoln, R.I., and the Palm Connected Organizer™ personal data assistant (PDA) by Palm, Inc. of Santa Clara, Calif.

Typically, the pen-enabled computing system senses the position and/or movement of the writing stylus with respect to the electronic writing tablet, which is stored in the pen-enabled computing system as a series of electronic ink data points constituting the handwriting input. In these systems, the electronic ink data points consist of, or are converted to, sets of Cartesian coordinates representing points along the path of the writing stylus as it moves with respect to the electronic writing tablet. The handwriting input is often then desirably used for other purposes. However, for the handwriting input to be subsequently utilized, it is often translated from the user's handwriting to text form. While text translation schemes may facilitate practical uses for the handwritten data, they are often not able to accurately translate the user's handwriting. In addition, translation routines may require additional processing and storage capacity which could be used for other purposes and may add size and cost to the pen-enabled computing system.

Some conventional pen-enabled computing systems utilize handwriting input without necessarily requiring the handwriting input to first be translated into text form. Typically, in these systems, the pen-enabled computing system stores the sets of Cartesian coordinates to allow the system or a separate computer or processor to reconstruct the handwriting input, either immediately or at a later time. Conventional representations of sets of coordinates may require several (e.g., three or four) bytes per coordinate pair. As such, a single paper page of handwriting can consist of thousands of coordinate pairs. In this regard, conventional systems may require several thousand bytes to represent a single paper page. Thus, conventional systems may require significant storage capacity and communications bandwidth to store and transmit electronic ink data.

Other pen-enabled computing systems have been developed that interact with preprinted forms. One such system is provided by U.S. patent application Ser. No. 09/540,469 to Clary, entitled System, Computer Program Product, Computing Device, and Associated Methods for Form Identification and Information Manipulation, filed Mar. 31, 2000, assigned to Advanced Digital Systems, Inc., also the assignee of the present invention, and hereby incorporated herein by reference in its entirety. The '469 application discloses a system for identifying a preprinted form and interacting therewith. The system of the '469 application comprises a pen-enabled computing device having a writing stylus, a preprinted form, and a computer program product. The preprinted form is typically disposed on a handwriting capture interface and is capable of cooperating with the pen-enabled computing device to permit data input into the various fields of the form to be captured and processed. The preprinted form comprises a page having a writing surface, a visual form identifier disposed on the writing surface and adapted to identify the nature of the page to the user, and a plurality of fields defined by the writing surface. The computer program product executes within the pen-enabled computing device and cooperates therewith to determine the disposition of the writing stylus adjacent to the writing surface in order to actuate the pen-enabled computing device. Subsequently, the pen-enabled computing device is capable of detecting, capturing, and storing data input into the fields according to the nature of the page, wherein the nature of the page comprises a function and a specific identity. The nature of the page is also identifiable by the pen-enabled computing device based on the data input into a plurality of the fields on the writing surface.

### SUMMARY OF THE INVENTION

In light of the foregoing background, the present invention provides an improved system, computer program product and method for capturing and processing form data. The system, computer program product and method of the present invention provides feedback, such as aural and/or visual feedback, that facilitates proper operation of the pen-enabled computing device. In contrast, conventional paper-based electronic record making systems that do not provide feedback undesirably allow the pen-enabled computing to suffer from operating and/or function errors without the user's knowledge, such as the failure of electronic capture because of a power failure at the handwriting capture interface. By providing feedback, the present invention facilitates the user's awareness of improper operation of the pen-enabled computing device such that the user can correct any errors resulting in the improper operation.

The present invention also provides for verification of the handwriting input at the point of capture, such as by the pen-enabled computing device. For example, the present invention can apply business rules to the handwriting input to ensure consistent, logical and complete capture and subsequent processing of the handwriting input. In addition, the present invention also provides for verification of handwriting input subsequent to capture of the handwriting input. In this regard, the present invention includes character recognition at the point of capture of the handwriting input, such as at the pen-enabled computing device, and subsequent additional character recognition, such as at a point remote from the pen-enabled computing device. By performing character recognition multiple times on the handwriting input and according to different character recognition schemes, the present invention can verify the character recognition performed at the point of capture by comparing the same with the additional character recognition to thereby provide higher accuracy of the character recognition results than performing either character recognition independent of the other.

Additionally, the present invention associates handwriting input received into fields of an electronic form with a form definition of the handwriting input. In contrast, conventional paper-based electronic record making systems typically include scanned or facsimile images of paper forms upon which handwriting input is associated. Because such conventional systems are paper-based, the image acquired by scanning of facsimile undoubtedly includes noise introduced during the scanning or faxing process, which can distort the image of the paper form. By associating the handwriting input with a form definition as opposed to a scanned or facsimile image of the form, the present invention avoids the noise introduced during such scanning or faxing of the paper form.

According to one embodiment, a pen-enabled computing device includes a handwriting capture interface, a user interface and a processing element. The handwriting capture interface is capable of receiving and capturing an electronic handwriting input within at least one input field of an electronic form based upon a position of a writing stylus. To facilitate proper operation of the pen-enabled computing device, the user interface is adapted to provide feedback based upon the electronic handwriting input. In another embodiment, the user interface provides the feedback further based upon a form definition and/or at least one business rule, where the form definition is associated with the electronic form.

The feedback provided by the user interface can include aural, visual and/or vibration feedback. In this regard, the user interface can include a display adapted to present the electronic handwriting input, where the display is capable of presenting an image comprising a thumbnail window, a form identifier field, a scroll-down window and/or an exploded view window. The thumbnail window can include a sketch of the electronic form including the field(s), where the sketch further includes associated electronic handwriting input within at least one field of the electronic form as the electronic handwriting input is captured. The form identifier field includes at least one form identifier associated with the electronic form. The scroll-down window includes an enlarged representation of the field(s) of the electronic form, where the scroll-down window is capable of scrolling depending upon a size of the electronic form. And the exploded view window includes at least one selected field of the electronic form, where the exploded view window is capable of showing the electronic handwriting input associated with the selected field.

The processing element, which is in communication with the handwriting capture interface and the user interface, is capable of detecting a type of electronic handwriting input based upon the electronic handwriting input received and/or the position of the writing stylus. For example, the processing element can detect handwriting input consisting of free-form handwriting input, handwriting input for character recognition, at least one checkbox selection and/or at least one radio button selection. The processing element can further process the electronic handwriting input based upon the type of electronic handwriting input. In this regard, the processing element is capable of compressing and/or storing the electronic handwriting input. When the electronic handwriting input comprises handwriting input for character recognition, the processing element can convert the electronic handwriting input into a text representation of the electronic handwriting input. And when the type of input detected comprises at least one of a checkbox selection and a radio button selection, the processing element can record the selections.

The handwriting capture interface and/or the user interface can receive an initiating action to thereby initiate a form processing action based upon at least one form identifier that can be associated with at least one form definition. In this regard, the processing element is further capable of initializing the electronic form based upon the form identifiers and the associated form definitions.

According to another aspect of the present invention, a system for communicating packaged data includes a pen-enabled computing device and a second computing device, such as a server computing device. The packaged data includes at least one form identifier and processed electronic handwriting input. According to the system, the pen-enabled computing device is capable of transmitting the packaged data, and the second computing device capable of receiving the packaged data. Thereafter, the second computing device can parse the packaged data into the form identifiers and the processed electronic handwriting input. In one embodiment, the packaged data further includes compressed free-form handwriting input. In this embodiment, the second computing device is further capable of uncompressing and/or storing the compressed free-form handwriting input. In one embodiment, the second computing device includes a database capable of storing the packaged data, the form identifiers and/or the processed electronic handwriting input parsed from the packaged data. And in another embodiment, the second computing device is capable of transmitting the packaged data and/or the processed electronic handwriting input.

The second computing device can also verify the processed electronic handwriting input when the processed electronic handwriting input comprises at least one of a text representation of handwriting input for character recognition and a selection associated with at least one of a checkbox and a radio button. In this regard, when the processed electronic handwriting input comprises at least one selection associated with a checkbox and/or a radio button, the second computing device is capable of verifying a selection by applying at least one business rule to the selection based upon at least one form definition associated with the at least one form identifier.

When the packaged data includes a text representation of the handwriting input for character recognition, the packaged data further includes an associated handwriting input for character recognition, i.e., generally the same handwriting input that was previously converted to text. To verify the text representation of the handwriting input, the second computing device can convert the handwriting input into at least one additional text representation of the handwriting input according to different conversion methods. The second computing device can then compare the additional text representations of the handwriting input and the text representation of the handwriting input. Thereafter, the second computing device is capable of selecting an acceptable text representation of the handwriting input based upon the comparison to thereby verify the text representation of handwriting input for character recognition.

According to one embodiment, the second computing device can compare the additional text representations of the handwriting input and the text representation of the electronic handwriting input by calculating at least one combined confidence value for the additional text representations of the handwriting input and the text representation of the handwriting input, where calculating the combined confidence values includes combining at least one confidence value associated with the respective text representations of the handwriting input. Then, the second computing device can compare the combined confidence values to determine the combined confidence value having the highest combined confidence value such that the acceptable text representation comprises the text representation associated with the highest combined confidence value.

For example, handwriting input for character recognition can include a plurality of handwritten characters, where the text representation of the handwriting input comprises at least one text representation for each handwritten character having respective confidence values. In this regard, the second computing device can convert each handwritten character into at least one additional text representation of the handwritten character having respective confidence values, where combining the confidence values comprises combining, for each different text representation of a handwritten character, the confidence values for the respective text representation and at least one additional text representation of the handwritten character. As such, the second computing device can compare the combined confidence values by comparing the combined confidence value for each different text representation of the handwritten character.

In another embodiment, the form identifiers are associated with at least one form definition for at least one electronic form. In this embodiment, the second computing device includes a database capable of storing the form definitions. Further, the second computing device is capable of associating the processed electronic handwriting input with at least one form definition associated with the form identifiers of the packaged data received from the pen-enabled computing device. As such, the processed electronic handwriting input is associated with the form definitions, as opposed to scanned and/or facsimile images of paper forms, as in conventional systems.

### BRIEF DESCRIPTION OF THE DRAWINGS

Having thus described the invention in general terms, reference will now be made to the accompanying drawings, which are not necessarily drawn to scale, and wherein:

FIG. 1 is a schematic diagram illustrating the pen-enabled computing device according to one embodiment of the present invention with an exploded view illustrating a series of electronic ink data points;

FIG. 2 is a block diagram illustrating some of the components of the pen-enabled computing device according to one advantageous embodiment of the present invention;

FIG. 3 is an example of a contacts form in accordance with one embodiment of the present invention;

FIG. 4 is an example of a medical form in accordance with one embodiment of the present invention;

FIG. 5 is another example of a medical form in accordance with one embodiment of the present invention;

FIGS. 6A and 6B are flow diagrams illustrating a method of capturing and processing form data by a pen-enabled computing device according to one embodiment of the present invention;

FIG. 7 is a schematic diagram illustrating one example of a display of a pen-enabled computing device according to one embodiment of the present invention;

FIG. 8 depicts a system for transmitting and/or processing form data according to one embodiment of the present invention; and

FIGS. 9A-9F are flow diagrams illustrating the further processing of form data according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

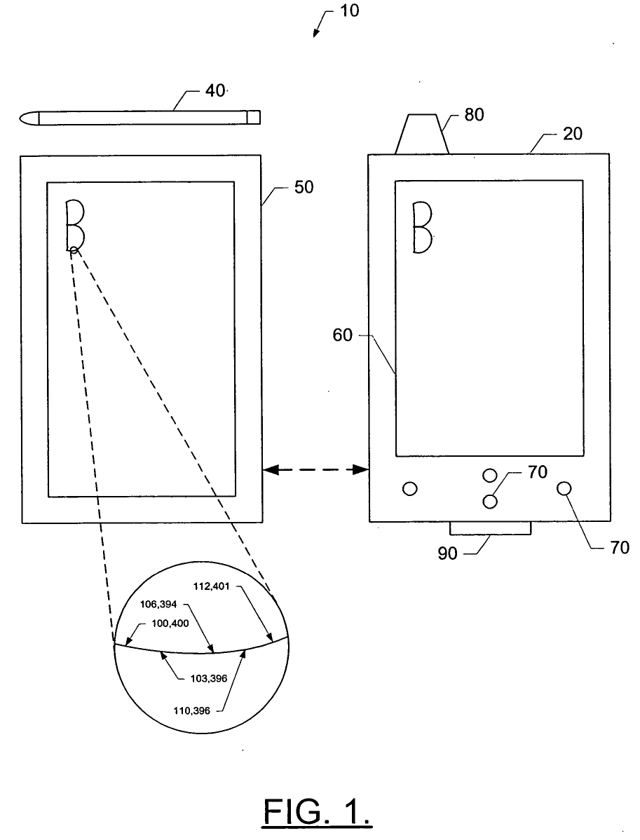

The pen-enabled computing device 10 of the present invention can be embodied in a number of different manners. In one advantageous embodiment depicted in FIG. 1, however, the pen-enabled computing device is a portable or handheld device, such as a personal digital assistant (PDA), a personal communication system (PCS), a smart phone, a portable computer or other type of portable or handheld computing device. However, the pen-enabled computing device can be a personal computer or any other type of stationary computing device so long as the first computing device is capable of capturing handwritten information and thereafter processing the handwritten information as described hereinbelow.

Although the pen-enabled computing device 10 can be embodied in many different manners, the pen-enabled computing device typically has a handwriting capture interface 50 that is responsive to a writing stylus 40. The pen-enabled computing device can include a variety of handwriting capture interfaces. For example, the handwriting capture interface can include a touch sensitive screen capable of identifying those points on the screen with which one or more objects, such as the writing stylus, a user's appendage (e.g., finger) or the like, comes into contact and for providing signals representative of the coordinates of the respective points on the screen. Additionally, or alternatively, the handwriting capture interface can include a screen with an electromagnetic digitizer that cooperates with the writing stylus to determine the position of the writing stylus relative to the screen at a plurality of successive instances in time Also, the pen-enabled computing device can include an electronic handwriting tablet as shown in FIG. 1 that cooperates with the writing stylus to determine the position of the writing stylus relative to the electronic handwriting tablet at a plurality of successive instances in time. In this regard, the writing stylus may include a radio transmitter, an ultrasound transceiver or the like for communicating with the electronic handwriting tablet. As such, the electronic handwriting tablet of these embodiments would include a corresponding receiver for detecting the signals indicative of the position of the writing stylus. Alternatively, the writing stylus can be designed to identify its position by optical, electric or magnetic means or by any other means known to those skilled in the art. For example, the pen-enabled computing device can include a writing stylus comprising an optical pen that can sense a pre-printed dot pattern on the handwriting capture interface to determine the position of the writing stylus.

In addition to capturing a plurality of “electronic ink” data points defining the position of the writing stylus over time, a written record of the handwritten information may also be created. For example, a piece of paper can be mounted upon the electronic handwriting tablet such that the writing stylus concurrently marks upon the piece of paper while communicating with the electronic handwriting tablet to create the plurality of “electronic ink” data points. In yet another alternative embodiment, the writing stylus may be designed such that the writing stylus itself detects its relative position with respect to a piece of paper and then electronically communicates with the handwriting capture interface without employing a conventional electronic handwriting tablet. In these instances, the writing stylus may detect a faint dot pattern printed on the paper or sense the fibers of the paper in order to detect or determine its relative position with respect to the piece of paper. One system that includes a writing stylus that detects its position relative to a sheet of paper, in addition to detecting the type and identity of the sheet of paper from a dot pattern printed thereon, is provided by Anoto AB, a subsidiary of C Technologies AB of Lund, Sweden.

Regardless of the manner in which the handwriting capture interface 50 is embodied, the handwriting capture interface captures and provides a series of data points, typically represented by X,Y coordinate points, representative of the position of the writing stylus 40 at a plurality of successive instances in time. The set of coordinate points from the time at which the writing stylus initiates contact with the touch sensitive screen, electronic handwriting tablet or paper to the time at which the writing stylus is lifted from the touch sensitive screen, electronic handwriting tablet or paper defines a writing stroke, a plurality of which typically define the handwritten information that has been entered by the user.

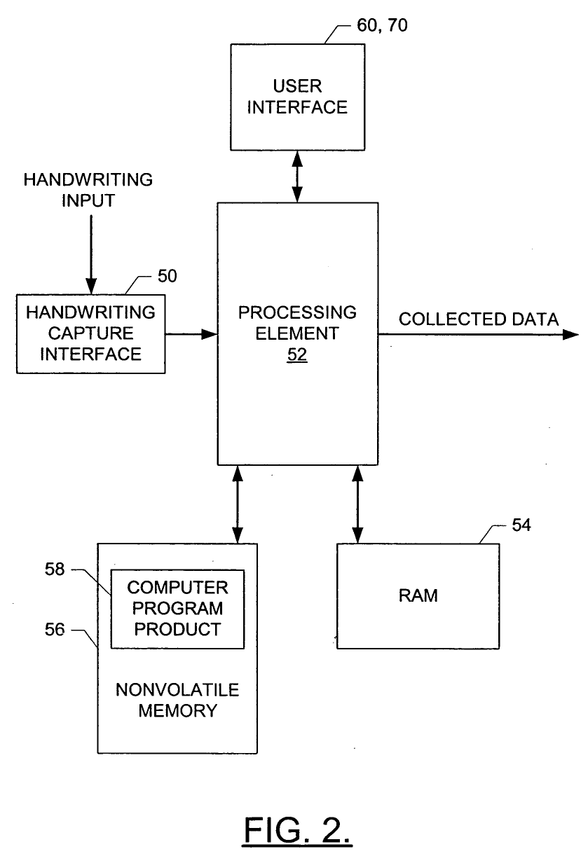

As shown in FIG. 2, in addition to the handwriting capture interface 50 and the writing stylus 40, the pen-enabled computing device 10 also includes a processing element 52, such as a central processing unit, and associated memory, such as random access memory (RAM) 54 and a non-volatile storage device 56. The non-volatile storage device, such as, for example, flash memory, an EEPROM or a disk, is typically used for storing and/or executing a computer program product 58 as well as storing useful data such as, for example, electronic ink data and/or compressed representations of the electronic ink data, as described below. Further, the RAM is generally used for loading and executing the computer program product and for storing various pieces of data during execution of the computer program product. As described below, the computer program product generally cooperates with the processing element to control the operation of the pen-enabled computing device 10. It should be understood, however, that even though the computer program product can control the operation of the pen-enabled computing device, this control can, instead, be accomplished through various hardware or firmware configurations without departing from the spirit and scope of the present invention. Generally, the computer program product can drive the handwriting capture interface to interface and cooperate with a writing stylus and can subsequently control the processing of the electronic ink data points that have been captured.

In the illustrated embodiment, the handwriting capture interface 50 is a discrete component from the remainder of the pen-enabled computing device 10, and is adapted to communicate with the remainder of the pen-enabled computing device, i.e., the processing element 52, via any conventional communications technique, including a wired connection, such as an RS232 connection, or a wireless connection, such as by means of a Bluetooth interface. In this regard, the embodiment of the pen-enabled computing device depicted in FIG. 1 includes an antenna 80 for facilitating wireless communication and an external device interface 90 for facilitating wired connections with the handwriting capture interface or other components. Additionally, although not illustrated, the pen-enabled computing device may include removable storage medium for uploading data to be downloaded by other components. However, the pen-enabled computing device can be formed as a single component with the handwriting capture interface, the processing element, the associated memory and any other elements assembled in a single package.

The pen-enabled computing device 10 can also include a user interface. The user interface includes provisions for facilitating interaction between the device and a user. The user interface may include a display 60 and one or more control buttons 70. The user interface may comprise, for example, one or more buttons for initiating functions within the device or for providing other types of input where, in some instances, the buttons may comprise a part of a keyboard or a keypad. The user interface may also comprise an apparatus for allowing the user to view displayed data or status information such as, for example, a viewing screen or monitor. Also, the user interface may comprise a touch screen that allows the user to input handwriting data directly into the device as part of the handwriting capture interface of the processing element. In some instances, the user interface may also include an audio mechanism such as, for example, a buzzer, bell, or other indicator or other devices capable of supporting voice interaction between the device and the user. Still further, for example, a vibration mechanism may also be used as an alert or acknowledgement indicator. In instances in which the user interface includes an audio mechanism and/or vibration mechanism in addition to the display, the pen-enabled computing device is capable of providing aural and/or visual feedback to the user as the user interacts with the device. Accordingly, the user interface may be implemented in many different manners, combinations thereof, and/or in conjunction with different components of the device.

According to one embodiment of the present invention, the handwriting input is captured and stored by the handwriting capture interface 50 as a coordinate representation of the movement of the writing stylus 40 relative to the handwriting tablet. In particular, the handwriting capture interface typically provides the processing element 52 with a plurality of electronic ink (X,Y) data points representative of the position of the writing stylus relative to the handwriting tablet at different points in time. In this context, a stroke is generally defined as a continuous marking by the writing stylus beginning with the commencement of contact or other interaction between the writing stylus and the handwriting tablet and terminating with the removal of the writing stylus from the handwriting tablet. For example, a “c” is generally formed of one stroke, while a “t” is generally formed of two strokes. As illustrated in FIG. 1, for example, a handwritten “B” can be formed of one stroke consisting of many electronic ink data points, the X,Y coordinates of five of which are shown in an exploded view.

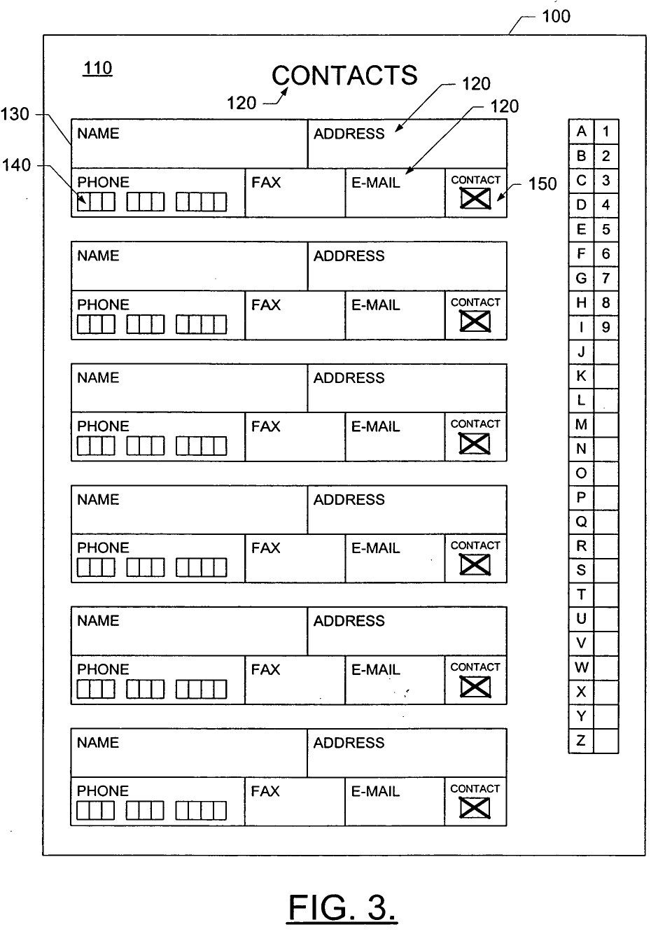

In addition to or instead of merely accepting free-form handwritten data, the pen-enabled computing device can be adapted to receive user input that is provided in response to a form mounted upon or displayed by the handwriting capture interface. In accordance with embodiments of the present invention, one purpose of the pen-enabled computing device is therefore to identify the nature of a preprinted form engaged therewith. Several examples of such forms may include a contact list form as shown in FIG. 3, a calendar form, a to-do list form, and a general notes form. Other examples of forms include, for instance, a trip planner form, a memorandum form, an educational form, a training form, an insurance form, a healthcare form, an expense accounting form, and a wide variety of other forms consistent with the spirit and scope of the present invention. In these embodiments, the computer program product 58 drives the handwriting capture interface to interface and cooperate with the writing stylus 40 through blank paper or certain preprinted forms. Note that while reference is made herein to interaction with a preprinted form, such reference is equally applicable to a blank piece of paper or the display 60 of the user interface, such as a touch screen that serves as a form, in accordance with the spirit and scope of the present invention.

Thus, according to one embodiment, the computer program product 58 enables the pen-enabled computing device 10 to, for example, sense a form identifier associated with a preprinted form, wherein the function and physical page of the preprinted form may be electronically identified. Such form identifiers may comprise, for example, a particular dot pattern sensed by the stylus 40, a numeric form ID, a bar code, a particular input field or fields associated with a form type, a form page, or a sub-area on a form, the particular spatial arrangement of input fields on a form, a voice input, a form definition identifier from a displayed definition menu, such as on the display 60 of the user interface, or many other types of form identifiers consistent with the spirit and scope of the present invention for identifying the function and physical page of the form. Further, in certain embodiments not involving a form, the form identifier may be directly associated with the handwriting capture interface 50, thus enabling operation of the pen-enabled computing device as described herein in the same manner as instances where a form is used. Accordingly, once the pen-enabled computing device interfaces with and identifies the preprinted form based upon the identified function and page number, the pen-enabled computing device is able to interpret and act upon data entered through input fields associated with the preprinted form, for example, a handwriting input. In particularly advantageous embodiments of the present invention, the handwriting input is captured and stored by the computer program product as vector-based data including, in some instances, (X, Y) coordinate pairs, temporal factors, tactile factors, and/or other descriptive data characterizing the handwriting input in a manner consistent with the spirit and scope of the present invention.

As shown in FIG. 3, a particular contacts form 100 comprises a writing surface 110, at least one visual identifier 120, and a plurality of fields for receiving data via the writing stylus 40, including fields such as for free-form handwriting 130, handwriting for character recognition 140, checkbox fields 150 and/or radio button groups. The fields are generally defined by a series of spatial coordinates so as to generally define a box or circle or other area configured to receive a data input therein corresponding to a particular function. For example, a field labeled “Address” is capable of identifying itself to a user and is expected to receive an input therein with the writing stylus corresponding to the address of a particular contact. In various embodiments discussed below, the pen-enabled computing device 10 is capable of identifying the fields and providing feedback to the user as to a selected field via visual and/or audio or speech synthesis, such as by tone or repeating the field label to the user. Further, activation of fields labeled, for example, “G” and “7” could indicate that the user wishes to store an entered record on the seventh page of all contacts having data within the “Name” field having the letter “G”. Thus, for a given type of form, the fields defined by the writing surface, along with the visual form identifiers, may combine to indicate a function of the form as well as a specific identity should the form comprise multiple pages or should there be multiple pages of one type of form.

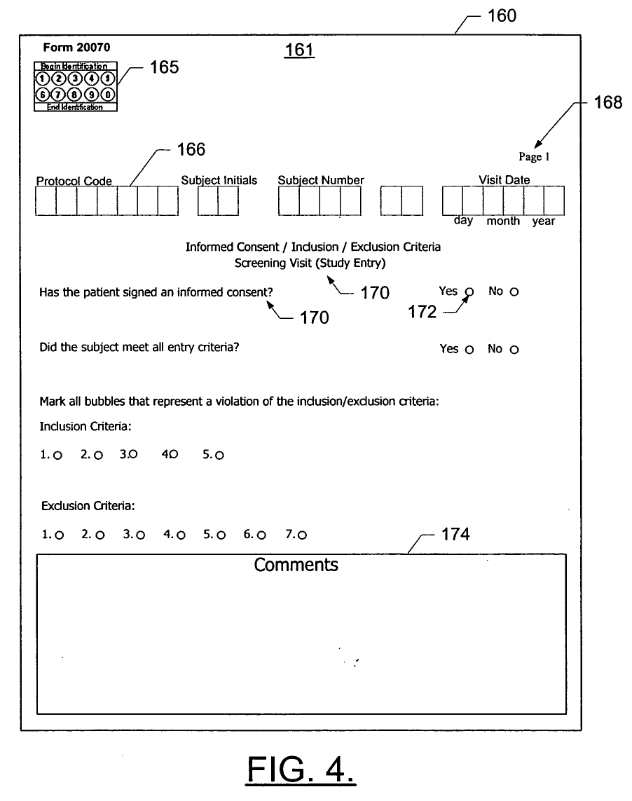

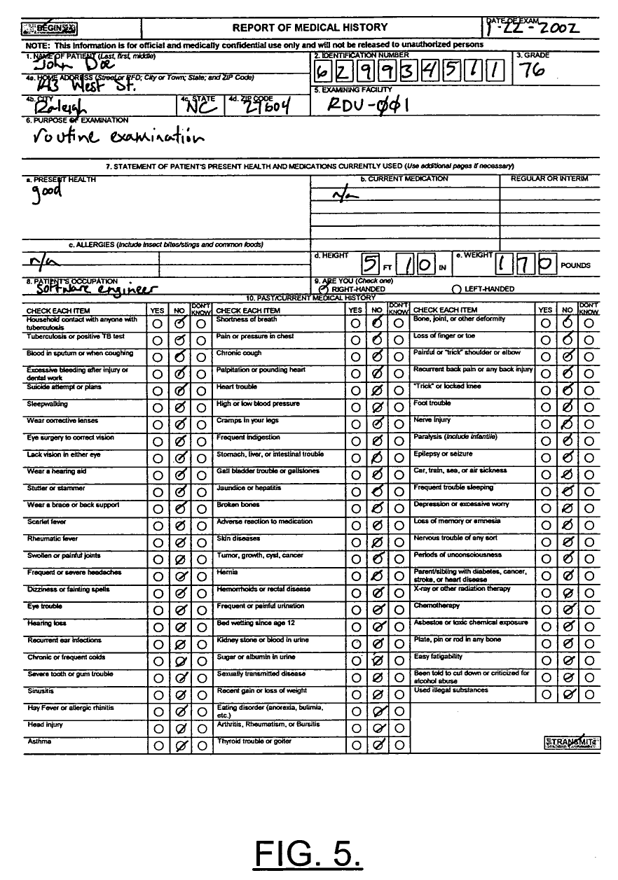

As other examples, the form could comprise a medical form, such as a screening visit form (see FIG. 4) or a medical history report form (see FIG. 5). As shown in FIG. 4, a particular medical form 160 comprises a writing surface 161, at least one visual identifier 170, and a plurality of fields for receiving data via the writing stylus 40, including fields such as for free-form handwriting 174, handwriting for character recognition 166, and mutually exclusive or inclusive markings such as radio button groups 172. Additionally, the form includes a page identifier 168 for identifying a particular page of a multi-page form. As depicted, for example, field labeled “Protocol Code” is capable of identifying itself to a user and is expected to receive an input therein with the writing stylus 40 corresponding to the code of a particular medical study protocol. Like the form illustrated in FIG. 3, in various embodiments, the pen-enabled computing device 10 is capable of identifying the fields and providing feedback to the user as to a selected field via visual and/or audio or speech synthesis, such as by tone or repeating the field label to the user.

Further, as described below, the form 160 may include a form-identification area 165, such as a designated “hot spot,” contained within a specific sub-area of the preprinted form overlying the electronic handwriting tablet. As discussed below, the user initiates the pen-enabled computing device 10 by identifying the desired form to the pen-enabled computing device. In the illustrated embodiment, the user identifies the desired form by using the writing stylus 40 to depress the area over the “Begin Identification” region. The user then enters the form identifier, such as the numeric ID “20070,” corresponding to the desired form by depressing the regions over the numbers corresponding to the numeric ID. Finally, the user completes the identification of the form by depressing the “End Identification” region. If the pen-enabled computing device recognizes the form identifier, the device will act accordingly as described below, and may additionally provide feedback, such as a voice synthesis message such as “20070record loaded.” But if the pen-enabled computing device does not recognize the form identifier, the device will act accordingly and may provide feedback, such as a voice synthesis message indicating “record not found,” for example.

Generally, the user interacts with the form according to the user-identified function imparted by the visual identifiers 120, 170. The user typically then enters data within the separate fields according to the functions thereof. The user may additionally enter data outside the fields of the form, however, particularly if the data comprises free-form handwriting input. Typically, as the data is entered into a field, it is spatially referenced with respect to the box defining the field. For example, data entered into a “Name” field may be referenced to the leftmost vertical boundary or possibly a combination of the leftmost vertical boundary and the lowermost horizontal boundary. Thereafter, data entered into an “Address” field may be referenced to the leftmost vertical boundary of the address box, which also corresponds to the rightmost vertical boundary of the name field. Thus, it is understood that data entered into defined fields on a form according to the functions thereof may be spatially referenced so as to be indicative of the nature of the form. It should also be understood that spatial representation of fields disposed on a form can also serve to differentiate between different types of forms. In order to add more specificity to the identification of a form, various fields may also be spatially disposed so as to define a unique code over other forms. For example, checking the appropriate fields on a daily scheduler form for a month and day differentiates the particular form from daily scheduler forms for other days throughout the year. Further details of the interaction between the pen-enabled computing device 10 and a preprinted form, according to some embodiments, are found in U.S. patent application Ser. No. 09/540,469 to Clary, entitled System, Computer Program Product, Computing Device, and Associated Methods for Form Identification and Information Manipulation, filed Mar. 31, 2000, assigned to Advanced Digital Systems, Inc., also the assignee of the present invention, and hereby incorporated herein by reference in its entirety.

Once the handwriting input is determined from the stylus 40 position and the usage of the fields of the preprinted form, the computer program product 58 is capable of assessing and separately processing the input data based upon the type of input, whether free-form handwriting input, handwriting input for character recognition, checkbox or radio button data, or some other form of input data. According to embodiments of the present invention wherein the handwriting input corresponds to that for character recognition, the computer program product may also convert or translate the handwriting input into text form using, for example, an automatic on-line handwriting recognizer or other translation system. However, in other embodiments, the handwriting input may be stored and further utilized without conversion into text, such as wherein the handwriting input corresponds to free-form handwriting, for example. Additionally, or alternatively, the computer program product may compress the handwriting input for easier storage, processing and/or transmission, particularly where the handwriting input is free-form handwriting and may comprise a large number of electronic ink data points. Such compression is described in further detail in U.S. patent application Ser. No. 09/768,949 to Hebert, entitled System, Device, Computer Program Product and Method for Representing a Plurality of Electronic Ink Data Points, filed Jan. 24, 2001, assigned to Advanced Digital Systems, Inc., also the assignee of the present invention, and hereby incorporated herein by reference in its entirety. In still further instances, the handwriting input, whether free-form or for character recognition, may be stored in its original form, in addition to possibly being converted to text form and stored by the computer program product, wherein either form, or both forms, of the handwriting input may be further utilized by the pen-enabled computing device 10.

In instances in which the input data corresponds to checkbox or radio button selections, the computer program product 58 stores the result of whether the checkbox has been checked or the radio button has been selected based on the spatial coordinates of the handwritten input and rules of logical exclusion or inclusion. If, after a checkbox or radio button has been selected, the user makes a new mark on the checkbox or radio button, the pen-enabled computing device 10 can provide feedback to the user, such as visual and/or audio or speech synthesis, to indicate that a selected checkbox or radio button as been reselected. Making a new mark in the checkbox and or radio button can also toggle the state of the stored result. For example, an additional mark on a selected checkbox causes that checkbox to be deselected. Alternatively, the new mark can select again a previously selected checkbox or radio button to thereby add to the previous selection, such as in cases where each mark in a checkbox increments a count of the number of times the user has selected the checkbox. In embodiments where the new mark selects a previously selected mark again, the checkbox or radio button can be deselected, or “scratched-out,” with at least one stroke over the checkbox or radio button. Thus, adding to or changing a selection can allow the state of the stored result to be consistent with the visual feedback on the preprinted form and/or the display.

Some embodiments of the present invention may also allow the data fields to be alterable by the user. For example, the present invention may allow the user to alter a field for free-form handwriting into a field for handwriting for character recognition, and vice versa. In addition, the computer program product 58 may have the ability to time and/or date stamp any data entries as they are entered into the pen-enabled computing device 10. The processing element 52 is then able to process these data fields with respect to the time and/or date stamp tags. As these functions are executed, the computer program product also controls the user interface such that information relevant to ongoing stylus 40 or pen-enabled computing device activities are displayed for the user, as described below. The pen-enabled computing device may provide aural and/or visual information to the user, including, for example audio tones or waveforms or speech synthesized voice messages or associated displays. In a particularly advantageous embodiment, the computer program product is also capable of formatting, sending, receiving, and interpreting messages received, such as via the antenna 80, removable storage medium, external communications interface 90 and/or a radio frequency transceiver (not shown).

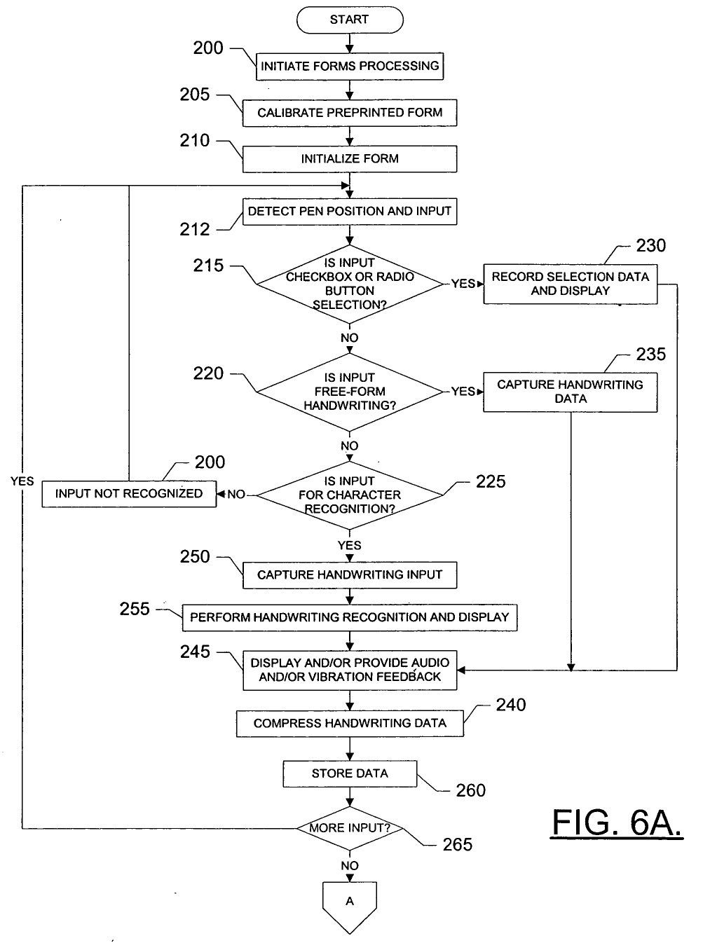

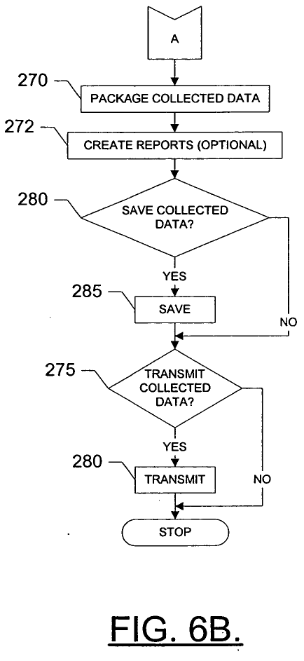

FIG. 6 shows a method for processing a form based on, or producing a contextual electronic message from, an input or inputs to a pen-enabled computing device 10 according to one embodiment of the present invention. According to embodiments of the present invention and as used herein, the term “contextual electronic message” refers to an electronic message formed on the basis of the particular preprinted form used within the pen-enabled computing device and the context of the handwriting input, such as the function of the form (e.g., “traffic crash report form”), a particular free-form comment, a particular text input field and/or a particular multiple choice question. For example, if a page from the contacts form 100 illustrated in FIG. 3 comprises the preprinted form and the handwriting input is an entry for a particular contact on that page, the context of the handwriting input may be a name, address or e-mail, a phone number, or a checkbox corresponding to whether to contact a respective entry, wherein the title (e.g., “Name,” “Address” and/or “E-Mail”) and related fields may correspond to visual identifiers 120 on the preprinted form. In accordance with various embodiments of the present invention, context may be affected by, for example, the particular form and/or sub-area thereof manipulated by the writing stylus 40, the user profile, characteristics of the message recipient, the particular series and/or order therein of user actions, and/or the characteristics of the user actions.

The content of the contextual message can be handwritten information such as, for example, a particular free-form comment, a particular text input field, predefined text and/or a particular multiple choice question. In addition, the content of the contextual message can include additional data that is related to or associated with the handwritten information. For example, this additional data can include additional text, such as one or more standard or predefined paragraphs or the text of an entire letter. Similarly, the additional data can include predefined audio, predefined video, links to web sites, photographs, pictures, or other images, letterhead, stationery or the like.

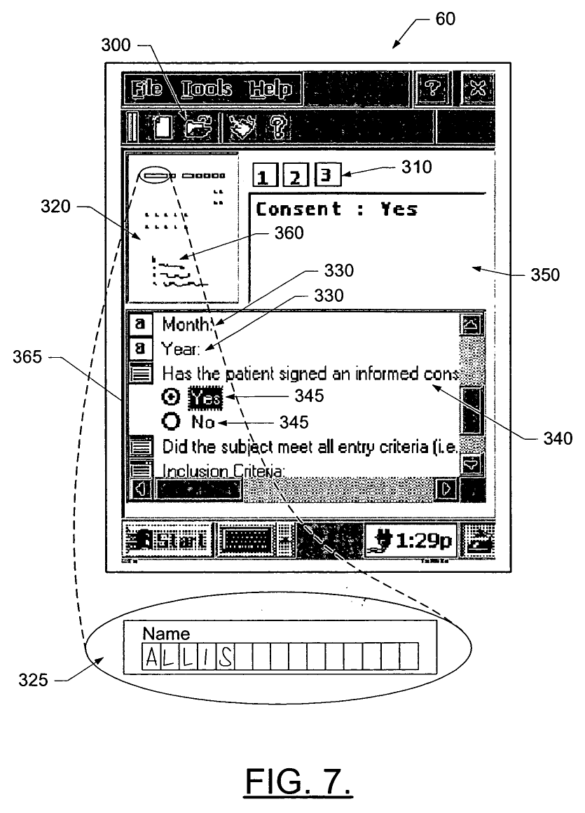

Again referring to FIG. 6, a user of a pen-enabled computing device 10 may first perform an initiating action to initiate the creation of a contextual electronic message or forms processing by the device (block 200). For example, the user may check a messaging box contained within a specific sub-area of the preprinted form overlying the electronic handwriting tablet or directly on the electronic handwriting tablet. Alternatively, the user may circle one or more fields contained within a specific sub-area of the preprinted form. In still another embodiment of the present invention, the user may select an electronic messaging icon that exists on the preprinted form such as, for example, an envelope icon appearing on the form, wherein each distinct sub-area of the form could have its own messaging icon. Further, in yet another embodiment of the present invention, the user may be required to activate a control button associated with the initiation of an electronic message. The user may, for example, be prompted by the user interface to select a messaging or forms processing option using associated control buttons, such as an open-file button 300, as shown in FIG. 7. Further details of the initiation of a contextual electronic message, according to some embodiments, are found in U.S. patent application Ser. No. 09/567,740 to Clary et al., entitled System, Computer Software Program Product, and Method for Producing a Contextual Electronic Message From an Input to a Pen-Enabled Computing System, filed May 10, 2000, assigned to Advanced Digital Systems, Inc., also the assignee of the present invention, and hereby incorporated herein by reference in its entirety.

During the interactions with the pen-enabled computing device 10, including interactions using the writing stylus 40, the device may provide aural and/or visual feedback to the user. Feedback may be given by the pen-enabled computing device when the stylus position input corresponds to predefined spatial areas. In such situations, the computer program product 58 is capable of recalling library and/or toolkit functions (e.g., those provided by a text-to-speech engine and/or those that play audio files) and producing aural (e.g., voice) or visual (e.g., graphical user interface (GUI)) feedback to the user. For example, as illustrated in FIG. 7, the device may provide visual feedback to the user by displaying one or more form identifiers, such as a page identifier 310, form identifier, and/or a thumbnail sketch 320 of the preprinted form on the display 60 once a recognized form has been identified. In addition, the display presented to the user may scroll to present information to the user, such as a question corresponding to the stylus position and corresponding choices for that question. In addition, or in the alternative, in embodiments wherein the pen-enabled computing device includes the audio mechanism and/or vibration mechanism, the device may provide an audio tone or voice message according to the position of the writing stylus to indicate whether a recognized preprinted form has been identified. And in some embodiments, the device may provide a voice message indicating that a preprinted form has been identified and/or the name of the identified form. In addition, the voice message may be synthesized based on text or other data stored in the predefined form definition. For example, a name or label associated with an input field may be spoken by the pen-enabled computing device when the stylus activates that field.

In some embodiments, the pen-enabled computing device 10 may prompt the user to complete initialization of the pen-enabled computing device by calibrating the preprinted form to align the input fields on the preprinted form with respect to a predefined point (block 205) or points. Calibration of input fields on the preprinted form with the pen-enabled computing device may be accomplished in many different ways, such as are known to those skilled in the art. For example, the user may be required to mark a portion of the preprinted form in a designated area or areas, such as a top corner and/or a bottom corner, to calibrate the preprinted form. After the user has calibrated the form, the pen-enabled computing device may provide aural and/or visual feedback to the user in a manner similar to that provided above indicating that the form has been calibrated and is now ready for input. Also, for example, calibration of input fields on the preprinted form may be accomplished using a separate calibration form and/or process, with or without any designated areas.

Once the user initiates the processing of a form, the pen-enabled computing device 10 creates and formats the desired form (block 210) in volatile storage 56, such as by loading the corresponding form definition and displaying a thumbnail sketch 320 of the identified form, as illustrated in FIG. 7. The form may include one or more sub-areas containing parameters indicating the type of form, a page number of the form, or the type of field within the form, which may advantageously be human readable. The user can enter the human readable parameters using input fields on the form or elements of the user interface of the pen-enabled computing device possibly to identify the form, page or instance to the device. In one particularly advantageous embodiment of the present invention not illustrated, the user can modify the contents of the form by interacting with the pen-enabled computing system through the stylus and/or the user interface components comprising, for example, an interactive display, appropriate control buttons, or the like.

After the pen-enabled computing device 10 has initiated the processing of a particular form, the pen-enabled computing device is then able to act on the input data, such as data entered into the fields associated with the form or data entered around the fields, such as free-form handwriting input. Whereas free-form handwriting input may be entered in the margins of the preprinted form, as well as within fields, reference herein will be made only to data entered into fields. It should be understood, however, that entering data into fields includes all data entered with respect to a preprinted form. The user may then begin entering data into a field on the preprinted form. Alternatively or additionally, in embodiments wherein the user interface includes a touch screen, screen with an electromagnetic digitizer, mouse, keyboard or the like, the user may enter data into fields using the touch screen, screen with an electromagnetic digitizer, mouse, keyboard or the like of the user interface. As the user enters handwritten, input data into the preprinted form, the handwriting capture interface 50 of the pen-enabled computing device captures the data and provides a series of data points, typically represented by X and Y coordinate points, indicating the depressed writing stylus 40 and representative of the position of the writing stylus at a plurality of successive instances in time. Alternatively, the pen-enabled computing device may only capture data and provide a single data point, representative of the position of the writing stylus at one instance of time, such as could be the case in instances in which the input data comprises a checkbox or radio button selection.

As the handwriting capture interface 50 accepts each piece of data, the pen-enabled computing device 10 may provide an audio, vibration and/or visual feedback to the user. For example, as the user enters handwriting input, the pen-enabled computing device may provide a sketch of each character 325 or stroke 360 on the display 60, such as within the thumbnail 320 of the form shown on the display. Additionally, or alternatively, the pen-enabled computing device may provide an audio tone or voice message corresponding to whether the device has accepted the data and/or the content of the data. In this regard, the pen-enabled computing device may include, stored within the nonvolatile memory 56, a set of predefined rules, such as business logic or other rules, as such are known to those skilled in the art. As the user enters input data, the processing element 52 may monitor the handwriting capture interface 50 and warn the user via visual and/or aural feedback if the predefined rules are violated. For example, a predefined rule may state that if the user activates a checkbox corresponding to “Lacks vision in either eye” on a medical history form (see FIG. 5), and subsequently fails to activate the checkbox corresponding to “Eye trouble,” a business rule violation has occurred. Additionally, the pen-enabled computing device may block the user from updating a database or transmitting the data if the rules have been violated.

Depending on the field or location where the user entered the data, the computer program product 58 assesses whether the data corresponds to handwriting input for character recognition, free-form handwriting input or a checkbox or radio button selection (blocks 215, 220 and 225). If the handwriting input corresponds to a checkbox or radio button selection, the computer program product records the selection (block 230). Additionally, the computer program product may store the chosen selection. The display may present the identifier for the field, such as a question on the form to be answered 340, along with the possible selections 345, such as answers to the question. Also, the display may provide a visual confirmation of the identifier for the data field and the selected response 350. Additionally, or alternatively, the pen-enabled computing device may provide an audio response that a selection has been made (block 245). If the handwriting input is free-form handwriting, the computer program product can capture the handwriting input from the handwriting capture interface as a series of electronic ink data points (block 235). The display, in turn, may display a sketch of the free-form handwriting input 360 on the thumbnail of the form and/or provide audio or vibration feedback to the user (block 245).

If the data corresponds to handwriting input for character recognition, the computer program product preferably converts or translates the handwriting input into text form using, for example, an automatic on-line handwriting recognizer or other translation system (blocks 250, 255). Additionally, the computer program product can, and preferably does, determine a confidence value associated with the text output from the handwriting recognizer or other translation system. In this regard, the computer program product can translate the handwriting input into one or more alternative text representations of each character and/or word according to one or more on-line and/or raster image based handwriting recognition or translation methods, with each representation having an associated confidence value. For each character or word of the handwriting input, the computer program product can then combine the confidence values associated with the alternative text representations of each character or word from the various recognition or translation methods. The combined confidence values for each text representation can then be compared to determine the text representation with the highest confidence value which, if the highest confidence value meets a predefined threshold, may be accepted by the computer program product as the text representation. Although the pen-enabled computing device preferably converts the handwriting input into the text representation, it should be understood that the pen-enabled computing device need not so convert the handwriting input. In this regard, the pen-enabled computing device can transmit, store and/or otherwise process the handwriting input for character recognition for later viewing or conversion by another device.

Once the computer program product identifies the data, the display provides feedback to the user, such as by providing a sketch of the entered characters 325 on the thumbnail 320 of the form. The pen-enabled computing device may also provide audio feedback in the form of a tone indicating data has been accepted and/or a voice message indicating the character recognized (block 245), which may include speech that represents the selection. Additionally, the handwriting input, and possibly text output and/or the associated confidence value, may be compressed (block 240) and/or stored (block 260) and further utilized by the pen-enabled computing device, such as by transmission to a second computing device to perform additional conversion or translation on the input, for example, using either on-line or off-line handwriting recognizers, or a combination of such recognizers. After the computer program product has assessed and processed the data, the pen-enabled computing device awaits for further input, such as in other fields associated with the preprinted form or other pages associated with a multi-page form (block 265). If the user inputs further information, the computer program product assesses the additional information in a manner similar to before.

Whereas the display 60 of the pen-enabled computing device 10 may comprise many different configurations, FIG. 7 illustrates one such configuration. It should be understood, however, that FIG. 7 is merely illustrative of one type of display configuration and should not be construed to limit the available types of display consistent with the spirit and scope of the present invention. The display comprises a plurality of windows situated throughout the area of the display. The display includes a thumbnail window 320 that displays a thumbnail sketch of the identified form. As the user enters handwritten data, the computer program product updates the thumbnail sketch with the contents of the input, whether it be handwriting input for character recognition 325, free-form handwriting input 360, checkbox input or radio button selection input. The display also includes at least one form identifier, such as a page identifier 310 to designate each page of a multiple page form. The display of the pen-enabled computing device includes a scroll-down window 365 that displays an enlarged view of some or all of the fields of the form as the user selects a field. The window is capable of scrolling up or down depending on the location of the selected field, however, the window need not scroll at all if the form is of such size that all fields can be displayed legibly within the window. As the user selects a field on the form, the display may also include an exploded view window 350 that includes an exploded view of the current, selected field, and may include the contents of the input data as the user enters such data into the pen-enabled computing device.

When the user has finished entering all the data for a particular form or forms, the user may save the data within the pen-enabled computing device, such as within the non-volatile storage device 56 (blocks 280, 285). Additionally, or alternatively, the pen-enabled computing device may automatically save the data at certain time intervals. Also, once the user has finished entering all the data for a particular form or forms, the computer-program product 58 collects all of the data and packages it together, including, for example, the form identifier, page identifier, an instance/session identifier, a user identifier, date and time stamp information, selected checkboxes and/or radio buttons, compressed free-form handwriting, compressed handwriting input for characters recognized, characters recognized from character recognition input and/or the confidence values associated with the recognized characters (block 270). While the data can be packaged in any number of formats, in one particularly advantageous embodiment, the computer program product packages the data into the Extensible Markup Language (XML) format. Formats such as the XML format facilitate a standard intercomputing systems data exchange, such as with healthcare and insurance computing systems. This packaged data can be used by the pen-enabled computing device to create user-defined reports based upon the entered data and the associated form, and can include the associated data in reports incorporating previously processed data associated with the same form, such as a running report of several entries in a particular form or field (block 272).

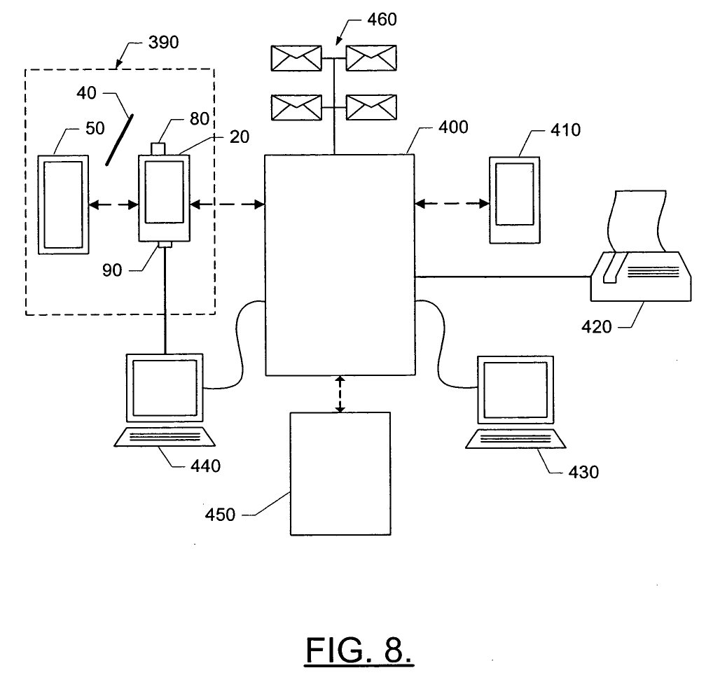

Additionally, the pen-enabled computing device can transmit the packaged data through the antenna 80, external communications interface 90 and/or or removable storage medium to an external component for further processing of the packaged data, such as further formatting, interpreting and otherwise processing the packaged data (blocks 275, 280). In this regard, FIG. 8 illustrates a system that includes a first computing device 390, such as a pen-enabled computing device according to the present invention, that is capable of transmitting handwritten information to a second computing device 400. The second computing device is typically a server that is adapted to receive the handwritten data transmitted by the first computing device and to thereafter process the handwritten data. However, the second computing device can be any of a variety of other types of computing devices, such as a mainframe computer, a personal computer, a workstation or the like, so long as the second computing device is capable of performing the functions described hereinbelow.

Typically, the second computing device 400 is adapted to further store, transmit messages, maintain a database, and/or create form definitions related to packaged data. In this regard, the second computing device includes at least one database 450 or at least one interface to at least one database, such as local and/or external databases, for maintaining a set of known form definitions and associated data, such as previously packaged data from known forms. As such, the second computing device can identify the form that the user has completed from among the set of known form definitions based on the form identifier provided by the first computing device 390. The second computing device can then store the packaged data in the database for later viewing or transmitting, such as over the Internet, for example. Additionally, the second computing device can also maintain the database by accepting new or updated form definitions and/or updated versions of the computer program product, with the second computing device capable of updating the first computing device with the new or updated definitions and/or updated computer program product. As such, a user of the first computing device is capable of filling out the new and/or updated forms associated with the new and/or updated form definitions updated by the second computing device. In this regard, in some embodiments the second computing device can additionally function as a system integrity regulator to thereby ensure that the first computing device contains the current, updated computer program product before the first computing device transmits data.

In various embodiments, the second computing device 400 may also serve to allow a user to create the form definitions that will thereafter be stored in the database 450 and used by the first computing device 390 and/or the second computing device. In this regard, the second computing device may include a computer program product (not illustrated). The computer program product may include a GUI compatible with any number of computing devices, such as a web interface or personal computer application. The computer program product is capable of allowing the user to create form definitions including field locations with X and Y digitizer coordinates, field identifiers such as questions to be presented to the user of the first computing device, feedback controls for visual and/or aural feedback, and constraints for character recognition. Additionally, the second computing device may be capable of accepting existing forms, such as forms scanned into the second computing device, wherein the computer program product associated with the second computing device will allow the user to use the existing forms as the basis for form definitions.

Additionally, or alternatively, the second computing device 400 may transmit messages including a contextual electronic message derived from the packaged data to a variety of remote devices, such as a personal computer 430, a facsimile machine 420, an e-mail server 460, a PDA, a PCS or other computing device 410 having e-mail, facsimile, or instant messaging capability, such that the intended recipient can receive and view all of or parts of the form including parts of the packaged data. In addition, or in the alternative, remote devices such as the personal computer may be used to create the form definitions stored in the database in a manner similar to that provided above with respect to the second computing device.

The first and second computing devices 390 and 400 and, in turn, the second computing device and the remote devices can communicate in a variety of different manners. For example, the first and second computing devices can communicate wirelessly, such as by means of a wireless local area network (LAN) or a wireless wide area network (WAN). In this regard, both the first and second computing devices can include transceivers for wirelessly transmitting handwritten data. Alternatively, the first and second computing devices can be connected via a conventional wired LAN or wired WAN or by any other wired connection. As such, both the first and second computing devices can include external device interfaces for supporting the wired connection. As will be apparent to those skilled in the art, the first and second computing devices may be configured to communicate directly or may communicate indirectly via one or more intermediate computing devices, such as the intermediate personal computer 440, depicted in FIG. 8, or intermediate servers, not illustrated.

In addition to being capable of being interconnected by a variety of different manners, the first and second computing devices 390 and 400 can communicate by any of a number of different communications protocols, although standard Internet communication protocols are typically preferred. Similarly, the second computing device is capable of communicating with the remote devices by any of a number of different manners, such as via wireless connections or wired connections as illustrated in FIG. 8. Furthermore, the second computing device can communicate with the remote devices according to any of a variety of communications protocols, although standard Internet communications protocols are also preferred. Additionally, while the system depicted in FIG. 8 illustrates a second computing device that communicates with a variety of remote devices, the system may be designed such that the first computing device communicates directly with one or more remote devices such that the remote device and the second computing device are one and the same.

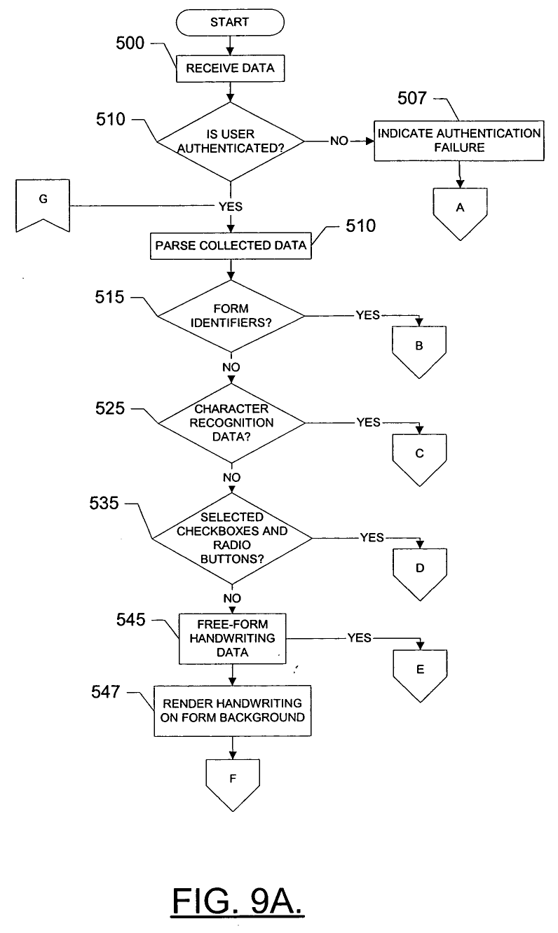

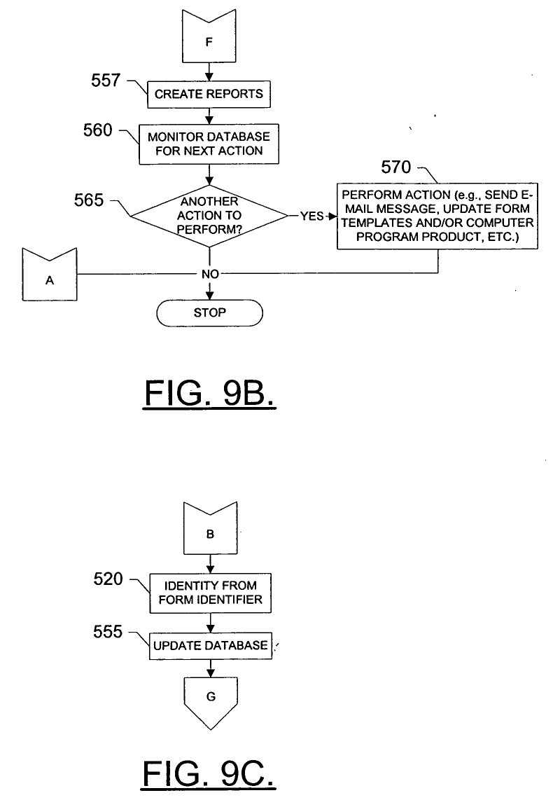

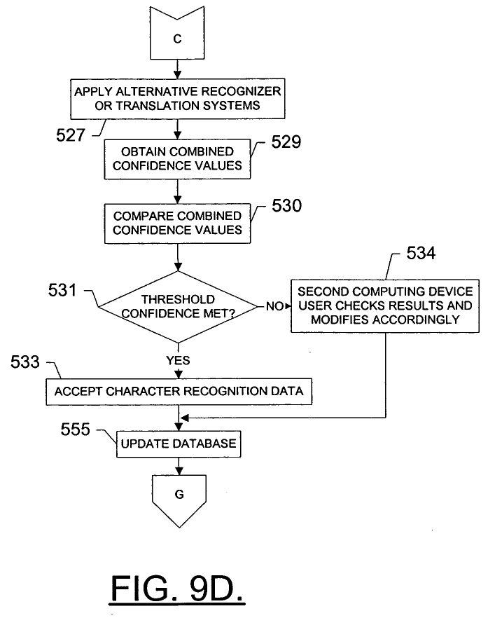

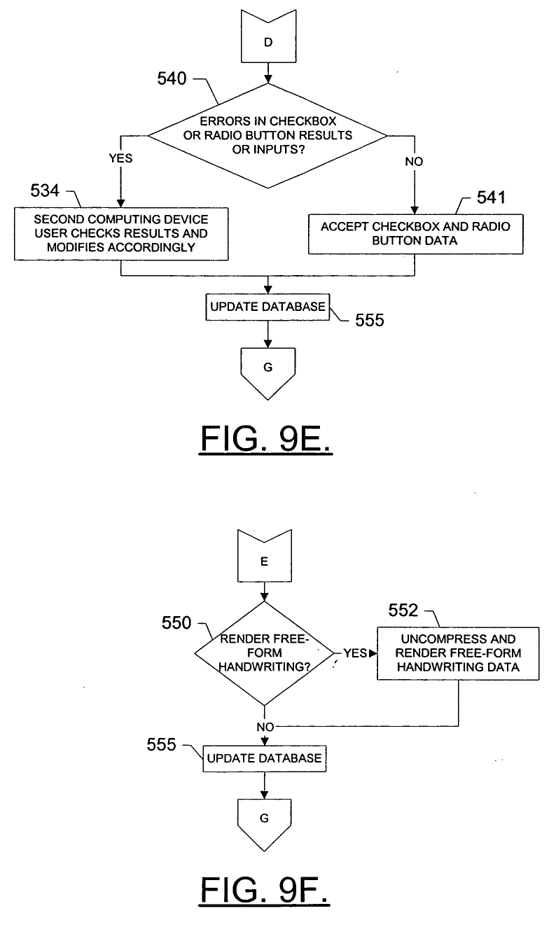

Referring to FIGS. 9A-9F, in operation, the second computing device 400 receives the packaged data from the first computing device 390 (block 500). Whereas FIGS. 9A-9E and the description herein refer to the second computing device, it should be understood that any of the functions performed by the second computing device can additionally, or alternatively, be performed by a remote device, such as the personal computer 430, without departing from the spirit and scope of the present invention. Preferably, the packaged data includes, for example, the form identifier, page identifier, an instance identifier, a session identifier, a user identifier, date and time stamp information, selected checkboxes or radio buttons, compressed free-form handwriting, compressed handwriting input for character recognition and characters recognized from character recognition input.

The second computing device 400, in turn, includes a processing element, such as a central processing unit, for further processing of the packaged data. In one embodiment, before the second computing device receives and processes the packaged data, however, the second computing device authenticates the user of the first computing device (block 505). The authentication can comprise any number of known methods, such as providing a username and password to the second computing device. If the second computing device fails to authenticate the user, the second computing device will indicate such failure to the first computing device such that the first computing device can notify the user, such as by visual and/or audio response in a manner similar to that described above (block 507). If the user of the first computing device 390 is authenticated, the second computing device begins to process the packaged data by parsing the collected data (block 510) into the different types of data, including form identifiers (block 515), page identifier, an instance identifier, a session identifier, a user identifier, date and time stamp information. Further, the second computing device can parse character recognition data (block 525) including a compressed representation of the handwriting input for character recognition verification and the characters recognized by the pen-enabled computing device, selected checkboxes and radio buttons (block 535), and compressed free-form handwriting input (block 545).

Referring to FIG. 9C, the second computing device 400 uses the form identifiers to identify the form within the database 450 associated with the data, including the associated field locations (block 520). With the character recognition data, the second computing device can verify the character recognition results by applying alternative on-line handwriting recognition or translation systems to the handwriting input for character recognition, as shown in FIG. 9D (block 527). In addition, or in the alternative, the second computing device or devices may apply multiple raster image based character recognition systems. In this regard, the second computing device renders the original handwriting input for character recognition, such as by decompressing the representation in a similar manner to the free-form handwriting input, discussed below. Then, the second computing device applies the alternative on-line and/or raster image based handwriting recognition or translation systems to translate the handwriting input obtain alternative results and associated confidence values, as such are known to those skilled in the art.

Similar to the computer program product of the first computing device (e.g., pen-enabled computing device), the alternative on-line and/or raster image based handwriting recognition or translation systems can translate the handwriting input into one or more alternative text representations of each character and/or word, with each representation having an associated confidence value. For each character or word of the handwriting input, the second computing device can then combine the confidence values associated with the alternative text representations of each character or word from the various recognizers or translation systems with the confidence values associated with the text representations from the first computing device (block 529). The combined confidence values for each text representation are then compared to determine the text representation with the highest confidence value (block 530). And if the highest confidence value meets a predefined threshold, the second computing device may accept the text representation (blocks 531, 533). Otherwise, a user associated with the second computing device may verify the result, such as by human inspection, and modify the data accordingly (block 534).

For example, presume the first computing device 390 recognized a particular handwriting input as representing the letter “O” with a confidence value of 14, and alternatively recognized the handwriting input as representing the letter “Q” with a confidence value of 8. Also, presume the second computing 400 device applied a single alternative handwriting translation system, which recognized the same handwriting input as representing the letter “O” with a confidence value of 94, and alternatively as representing the letter “C” with a confidence value of 4. To obtain an combined confidence value for each character, the second computing device combines all the confidence values associated with the respective recognized character to obtain a combined confidence value of 108 associated with “O,” a combined confidence value of 8 associated with “Q” and a combined confidence value of 4 associated with C. Based upon a comparison of the overall confidence values of the recognized characters, “O” is determined to be the text representation for the handwriting input having the highest confidence value. And if the predefined threshold is below 108, then “O” is accepted as the text representation for the handwriting input.

Referring to FIG. 9E with the selected checkboxes and radio buttons, the second computing device 400 can verify and/or facilitate verification of the results. In this regard, the second computing device can also include a set of business rules associated with particular form definitions to check the selected checkboxes and radio buttons for violations of such rules, such as multiple choices made in any field, extra marks or marks outside of checkboxes (block 540). Additionally, or alternatively, the second computing device can facilitate verification by providing a display including the selected checkboxes and radio buttons such that the display of the selected checkboxes and radio buttons can be checked for errors, such as by a user of the second computing device. If errors exist, the second computing device may notify the user associated with the second computing device who may, in turn, verify the error, such as by human inspection, and adjust the data accordingly (block 534). As shown in FIG. 9F, with the compressed free-form handwriting input, the second computing device can uncompress or otherwise process the free-form handwriting input to render the original handwriting input if so desired (blocks 550, 552). Such a method for uncompressing the handwriting input is provided in U.S. patent application Ser. No. 09/768,949 to Hebert, entitled System, Device, Computer Program Product and Method for Representing a Plurality of Electronic Ink Data Points. Additionally, or alternatively, the second computing device can store the compressed free-form handwriting input without uncompressing or otherwise processing the free-form handwriting input, such as when the second computing device updates the database without first rendering the original handwriting input.

In addition to the handwritten information, packaged data from the first computing device can include additional data related to or associated with the handwritten information. As such, according to one aspect of the present invention, the second computing device 400 can identify the additional data that relates to or is associated with the handwritten information. In this regard, the user of the first computing device 390 can provide the second computing device with instructions, either concurrent with the transmission of the packaged data or at some time prior to the transmission of the packaged data. These instructions would identify the additional data to be included with the handwritten information. Alternatively, the second computing device or some other component of the system can include prestored instructions indicating the additional data that is to be provided. For example, the prestored instructions may indicate that all messages to a particular recipient should include a predefined letterhead or background image and should further include additional text that has also been previously stored.

As such, in instances in which the second computing device 400 determines that additional data relates to or is associated with the handwritten information and is to be included in the message transmitted to the intended recipient, the second computing device can create a composite, such as a composite image, message, record or file, including both the handwritten information and the additional data. In one embodiment, the second computing device can then create a composite with both the image of the handwritten information and the additional data included, albeit separately.

In some embodiments, however, the handwritten information is desirably superimposed upon the additional data, such as in instances in which the additional data is letterhead, stationery or some other background image. In these embodiments, the second computing device 400 can overlay the handwritten information upon the additional data in such a manner that in those locations at which the handwritten information overlaps the additional data, the additional data is to be treated as being transparent such that the handwritten information will appear to be overlaid upon the additional data (block 547). By relying upon the second computing device of either embodiment to associate the handwritten information and the additional data, the first computing device 390 need not store the additional data and need not transmit the additional data at or near the time at which the packaged data is transmitted to the second computing device, if at all, thereby conserving both the memory of the first computing device and the bandwidth required to transmit the packaged data between the first and second computing devices. Further details of processing the handwritten information and additional data can be found in U.S. patent application Ser. No. 09/769,115 to Clary et al., entitled System, Computer Software Product and Method for Transmitting and Processing Handwritten Data, filed Jan. 24, 2001, assigned to Advanced Digital Systems, Inc., also the assignee of the present invention, and hereby incorporated herein by reference in its entirety.

After the second computing device 400 processes the packaged data, the second computing device will update one or more databases 450 with the data using any of a number of standard Application Programming Interfaces (APIs), preferably Open Database Connectivity (ODBC), as shown in FIGS. 9C-9F (block 555). Additionally, as shown in FIG. 9B, the second computing device can create reports based upon the data, and can include the data in reports incorporating data previously processed from the same form, such as a running report of several entries in a particular form or form identifier (block 557). The second computing device can also monitor the database(s) and/or take a next action step resulting from updating the database, such as send an e-mail message containing the processed data (blocks 560, 565 and 570).

In one advantageous embodiment, portions of the system and method of the present invention, such as portions of the pen-enabled computing device 10 include a computer program product 58. The computer program product includes a computer-readable storage medium, such as the non-volatile storage medium, and computer-readable program code portions, such as a series of computer instructions, embodied in the computer-readable storage medium for receiving the handwritten data and associated data and for subsequently processing and transmitting the handwritten data as described hereinabove. Typically, the computer program is stored by the processing element or a related memory device, such as the non-volatile storage device 56 as depicted in FIG. 2.

In this regard, FIGS. 1, 2, 6, 8 and 9 are block diagram, flowchart and control flow illustrations of methods, systems and program products according to the invention. It will be understood that each block or step of the block diagram, flowchart and control flow illustrations, and combinations of blocks in the block diagram, flowchart and control flow illustrations, can be implemented by computer program instructions. These computer program instructions may be loaded onto a computer or other programmable apparatus to produce a machine, such that the instructions which execute on the computer or other programmable apparatus create means for implementing the functions specified in the block diagram, flowchart or control flow block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagram, flowchart or control flow illustrations, and combinations of blocks or steps in the block diagram, flowchart or control flow illustrations, can be implemented by special purpose hardware-based computer systems which perform the specified functions or steps, or combinations of special purpose hardware and computer instructions.

Therefore, the system, computer program product and method of the present invention provides feedback, such as aural and/or visual feedback, that facilitates proper operation of the pen-enabled computing device by facilitating the user's awareness of improper operation of the pen-enabled computing device such that the user can correct any errors resulting in the improper operation. Also, the present invention provides for verification of the handwriting input at the point of capture, such as by applying business rules to the handwriting input to ensure consistent, logical and complete capture and subsequent processing of the handwriting input. The present invention also includes performing character recognition multiple times on the handwriting input to thereby verify character recognition performed at the point of capture to provide higher accuracy of the character recognition results than performing either character recognition independent of the other. Additionally, the present invention processes handwriting input captured on paper, screen or other writing medium received into fields of an electronic form according to a form definition to avoid noise introduced during scanning and/or faxing of paper forms, as in conventional systems.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method of communicating and processing packaged data from a pen-enabled computing device, said method comprising:
transmitting the packaged data, wherein the packaged data includes at least one form identifier and processed electronic handwriting input;
receiving the packaged data and thereafter parsing the packaged data into the at least one form identifier and the processed electronic handwriting input; and
verifying the processed electronic handwriting input when the processed electronic handwriting input comprises at least one of a text representation of handwriting input for character recognition and a selection associated with at least one of a checkbox and a radio button.

2. A method according to claim 1, wherein when the packaged data includes a text representation of handwriting input for character recognition the packaged data further includes an associated handwriting input for character recognition, and wherein verifying the text representation comprises:
converting the handwriting input for character recognition into at least one additional text representation of the handwriting input;
comparing the at least one additional text representation of the handwriting input and the text representation of the electronic handwriting input; and
selecting an acceptable text representation of the handwriting input based upon the comparison.

3. A method according to claim 2, wherein comparing the at least one additional text representation of the handwriting input and the text representation of the electronic handwriting input comprises:
calculating at least one combined confidence value for the at least one additional text representation of the handwriting input and the text representation of the electronic handwriting input, wherein calculating the at least one combined confidence value comprises combining at least one confidence value associated with the respective text representations of the handwriting input; and
comparing the combined confidence values to determine a combined confidence value having the highest combined confidence value,
wherein selecting an acceptable text representation comprises selecting the text representation associated with the highest combined confidence value.

4. A method according to claim 3, wherein the handwriting input for character recognition includes a plurality of handwritten characters, wherein the text representation of the handwriting input comprises at least one text representation for each handwritten character having respective confidence values, wherein converting the handwriting input for character recognition comprises converting each handwritten character into at least one additional text representation of the handwritten character having respective confidence values, wherein combining the at least one confidence value comprises combining, for each different text representation of a handwritten character, the confidence values for the respective text representation and at least one additional text representation of the handwritten character, and wherein comparing the combined confidence values comprises comparing the combined confidence value for each different text representation of the handwritten character.

5. A method according to claim 2, wherein converting the handwriting input comprises converting the handwriting input into a plurality of additional text representations of the handwriting input according to different respective conversion methods.

6. A method according to claim 1, wherein verifying a selection associated with at least one of a checkbox and a radio button comprises applying at least one business rule to the selection based upon at least one form definition associated with the at least one form identifier.

7. A method according to claim 1, wherein the packaged data further includes compressed free-form handwriting input, said method further comprising at least one of rendering the free-form handwriting input, uncompressing the compressed free-form handwriting input and storing the compressed free-form handwriting input, wherein at least one of uncompressing and storing the compressed free-form handwriting input occur after parsing the packaged data.

8. A method according to claim 1, wherein transmitting the packaged data comprises transmitting the packaged data from a pen-enabled computing device, and wherein receiving, parsing and verifying the processed electronic handwriting input occur at a server computing device located remote from the pen-enabled computing device.

9. A method according to claim 8 further comprising:
capturing handwriting input for character recognition at a pen-enabled computing device and thereafter converting the handwriting input into a text representation of the handwriting input, wherein the processed electronic handwriting input comprises the text representation of the handwriting input and the handwriting input, wherein capturing and converting occur before transmitting the packaged data, and
wherein verifying the text representation comprises:
converting the handwriting input into at least one additional text representation of the handwriting input;
comparing the at least one additional text representation of the handwriting input and the text representation of the electronic handwriting input; and
selecting an acceptable text representation of the handwriting input based upon the comparison.

10. A computer program product for communicating and processing packaged data from a pen-enabled computing device, the computer program product comprising a computer-readable storage medium having computer-readable program code embodied in said medium, the computer-readable program code comprising:
a first executable portion for transmitting the packaged data, wherein the packaged data includes at least one form identifier and processed electronic handwriting input;
a second executable portion for receiving the packaged data and thereafter parsing the packaged data into the at least one form identifier and the processed electronic handwriting input; and
a third executable portion for verifying the processed electronic handwriting input when the processed electronic handwriting input comprises at least one of a text representation of handwriting input for character recognition and a selection associated with at least one of a checkbox and a radio button.

11. A computer program product according to claim 10, wherein when the packaged data includes a text representation of handwriting input for character recognition the packaged data further includes an associated handwriting input for character recognition, and wherein said third executable portion verifies the text representation according to the following:
converting the handwriting input for character recognition into at least one additional text representation of the handwriting input for character recognition;
comparing the at least one additional text representation of the handwriting input and the text representation of the electronic handwriting input; and
selecting an acceptable text representation of the handwriting input based upon the comparison.

12. A computer program product according to claim 11, wherein said third executable portion compares the at least one additional text representation of the handwriting input and the text representation of the electronic handwriting input comprises by:
calculating at least one combined confidence value for the at least one additional text representation of the handwriting input and the text representation of the electronic handwriting input, wherein calculating the at least one combined confidence value comprises combining at least one confidence value associated with the respective text representations of the handwriting input; and
comparing the combined confidence values to determine a combined confidence value having the highest combined confidence value,
wherein said third executable portion selects the acceptable text representation by selecting the text representation associated with the highest combined confidence value.

13. A computer program product according to claim 12, wherein the handwriting input for character recognition includes a plurality of handwritten characters, wherein the text representation of the handwriting input comprises at least one text representation for each handwritten character having respective confidence values, wherein said third executable portion converting the handwriting input for character recognition by converting each handwritten character into at least one additional text representation of the handwritten character having respective confidence values, wherein said third executable portion combines the at least one confidence value by combining, for each different text representation of a handwritten character, the confidence values for the respective text representation and at least one additional text representation of the handwritten character, and wherein said third executable portion compares the combined confidence values comprises comparing the combined confidence value for each different text representation of the handwritten character.

14. A computer program product according to claim 11, wherein said third executable portion converts the handwriting input by converting the handwriting input into a plurality of additional text representations of the handwriting input according to different respective conversion methods.

15. A computer program product according to claim 11, wherein said third executable portion verifies a selection associated with at least one of a checkbox and a radio button by applying at least one business rule to the selection based upon at least one form definition associated with the at least one form identifier.

16. A computer program product according to claim 11, wherein the packaged data further includes compressed free-form handwriting input, said computer program product further comprising a fourth executable portion for at least one of rendering the free-form handwriting input, uncompressing the compressed free-form handwriting input and storing the compressed free-form handwriting input, wherein at least one of uncompressing and storing the compressed free-form handwriting input occur after parsing the packaged data.

17. A computer program product according to claim 11, wherein said first executable portion transmits the packaged data from a pen-enabled computing device, and wherein said second receives and parses the packaged data and said third executable portion verifies the packaged data at a server computing device located remote from the pen-enabled computing device.

18. A computer program product according to claim 17 further comprising:
a fourth executable portion for capturing handwriting input for character recognition at a pen-enabled computing device and thereafter converting the handwriting input into a text representation of the handwriting input, wherein the processed electronic handwriting input comprises the text representation of the handwriting input and the handwriting input, wherein said fourth executable portion captures and converts the handwriting input occur before said first executable portion transmits the packaged data, and
wherein said third executable portion verifies the text representation by:
converting the handwriting input into at least one additional text representation of the handwriting input;
comparing the at least one additional text representation of the handwriting input and the text representation of the electronic handwriting input; and
selecting an acceptable text representation of the handwriting input based upon the comparison.

19. A system for communicating packaged data, said system comprising:
a pen-enabled computing device capable of transmitting the packaged data, wherein the packaged data includes at least one form identifier and processed electronic handwriting input; and
a second computing device capable of receiving the packaged data and thereafter parsing the packaged data into the at least one form identifier and the processed electronic handwriting input, wherein said second computing device is further capable of verifying the processed electronic handwriting input when the processed electronic handwriting input comprises at least one of a text representation of handwriting input for character recognition and a selection associated with at least one of a checkbox and a radio button.

20. A system according to claim 19, wherein when the packaged data includes a text representation of handwriting input for character recognition the packaged data further includes an associated handwriting input for character recognition, wherein said second computing device is capable of converting the handwriting input for character recognition into at least one additional text representation of the handwriting input for character recognition, wherein said second computing device is capable of comparing the at least one additional text representation of the handwriting input and the text representation of the electronic handwriting input, and wherein said second computing device is capable of selecting an acceptable text representation of the handwriting input based upon the comparison to thereby verify the text representation of handwriting input for character recognition.

21. A system according to claim 20, wherein said second computing device is capable of comparing the at least one additional text representation of the handwriting input and the text representation of the electronic handwriting input by calculating at least one combined confidence value for the at least one additional text representation of the handwriting input and the text representation of the electronic handwriting input by combining at least one confidence value associated with the respective text representations of the handwriting input, and thereafter comparing the combined confidence values to determine a combined confidence value having the highest combined confidence value, wherein said second computing device is capable of selecting an acceptable text representation by selecting the text representation associated with the highest combined confidence value.

22. A system according to claim 21, wherein the handwriting input for character recognition includes a plurality of handwritten characters, wherein the text representation of the handwriting input comprises at least one text representation for each handwritten character having respective confidence values, wherein said second computing device is capable of converting the handwriting input for character recognition by converting each handwritten character into at least one additional text representation of the handwritten character having respective confidence values, wherein said second computing device is capable of combining the at least one confidence value by combining, for each different text representation of a handwritten character, the confidence values for the respective text representation and at least one additional text representation of the handwritten character, and wherein said second computing device is capable of comparing the combined confidence values by comparing the combined confidence value for each different text representation of the handwritten character.

23. A system according to claim 20, wherein said second computing device is capable of converting the handwriting input for character recognition into a plurality of additional text representations of the handwriting input according to different respective conversion methods.

24. A system according to claim 19, wherein said second computing device is capable of verifying a selection associated with at least one of a checkbox and a radio button by applying at least one business rule to the selection based upon at least one form definition associated with the at least one form identifier.

25. A system according to claim 19, wherein the packaged data further includes compressed free-form handwriting input, wherein said second computing device is further capable of at least one of uncompressing the compressed free-form handwriting input, rendering and storing the compressed free-form handwriting input.

26. A system according to claim 19, wherein said second computing device includes a database capable of storing at least one of the packaged data and the at least one form identifier and the processed electronic handwriting input parsed from the packaged data.

27. A system according to claim 19, wherein said second computing device is further capable of transmitting at least one of the packaged data and the processed electronic handwriting input.

28. A system according to claim 19, wherein the at least one form identifier is associated with at least one form definition for at least one electronic form, wherein said second computing device includes a database capable of storing the at least one form definition, and wherein said second computing device is capable of associating the processed electronic handwriting input with at least one form definition associated with the at least one form identifier of the packaged data received from said pen-enabled computing device.

29. A system according to claim 19, wherein said pen-enabled computing device is capable of capturing handwriting input comprising at least one free-form handwriting input, handwriting input for character recognition, at least one checkbox selection and at least one radio button selection, wherein said pen-enabled computing device is capable of converting the handwriting input for character recognition into a text representation of the handwriting input, wherein the processed electronic handwriting input comprises the text representation of the handwriting input and the handwriting input, wherein capturing and converting occur before transmitting the packaged data, wherein said pen-enabled computing device is capable of transmitting the packaged data to said second computing device located remote from said pen-enabled computing device, and wherein said second computing device comprises a server computing device.
